(19) United States
(12) Patent Application Publication
(10) Pub. No.: US 2024/0122408 A1
(43) Pub. Date: Apr. 18, 2024

(54) EMULSIFICATION SYSTEM WITH SERRATED KNIVES

(71) Applicant: COZZINI LLC, Elk Grove Village, IL (US)

(72) Inventors: Edwin Earl KING, Lombard, IL (US); Michael E. BURNS, Palatine, IL (US)

(21) Appl. No.: 18/378,780

(22) Filed: Oct. 11, 2023

Related U.S. Application Data
(60) Provisional application No. 63/415,850, filed on Oct. 13, 2022.

(51) Int. Cl. A47J 43/07; B01F 23/41; B01F 35/00

(52) U.S. Cl. CPC A47J 43/07; B01F 23/41; B01F 35/181; B01F 2101/06

(57) ABSTRACT

A cutting knife for a rotating emulsion system is provided. The knife includes a body with a bottom surface and a leading portion, the bottom surface and the leading portion collectively form a cutting edge. The body further comprises a portion that is configured to be inserted within a slot within a cutting assembly with the bottom surface and a portion of the leading portion extending outward from the slot, the cutting assembly configured to be rotated by a shaft that extends through a center hole in the cutting assembly and is fixed to the cutting assembly, wherein the leading portion is a surface of the body that faces the direction of rotation of the body as the cutting assembly is rotated, The cutting edge and the leading portion each form a plurality of serrations along at least a portion of a length thereof.

### CROSS-REFERENCE TO RELATED APPLICATIONS

This application claims priority from U.S. Provisional Patent Application No. 63/415,850, filed on Oct. 13, 2022, the entirety of which is fully incorporated by reference herein.

### TECHNICAL FIELD

The subject application relates to an emulsification system that is provided to emulsify or grind food product into small pieces or a slurry through multiple screens, and in the presence of multiple rotating cutting assemblies that cut the food particles into smaller and smaller sizes as the food product is pulled through the screens. Often, such as in pet food applications where a percentage of bone is allowed in a mixture with meat to be processed, the holes of the screens become blocked, which leads to frequent downtime to clean the components of the machine. Similarly, the bulk food presented within the device may include sinew, connective tissue, and cartilage that resists cutting and therefore may build up in front of the screen and block flow through the holes in the screen. The disclosed device is intended to prevent these and other problems known with conventional emulsification devices.

### BRIEF SUMMARY

A first representative embodiment of the disclosure includes an emulsion system. The emulsion system includes a shaft capable of rotation, and a housing that encloses the shaft. One or more screens are disposed about the shaft and within the housing, each of the plurality of screens are fixed with respect to the housing and remain stationary as the shaft rotates, each screen has a plurality of thru holes to allow a food product to pass therethrough. One or more cutting assemblies are disposed about the shaft and within the housing, the one or more cutting assemblies fixed to the shaft such that each cutting assembly rotates with rotation of the shaft. Each of the one or more cutting assemblies includes a hub with a plurality of arms that extend from the hub, the plurality of arms each include a slot for receipt of a removable knife. Each of the plurality of arms removably receives a cutting knife within the slot, wherein each cutting knife comprises a cutting edge and a side surface, the cutting edge and a portion of the side surface extends out of the slot when the knife is installed within the respective slot. The cutting edge and the side surface each form a plurality of serrations along at least a portion of a length thereof.

Another representative embodiment of the disclosure includes a cutting knife for an emulsification system. The cutting knife includes a body with a bottom surface and a leading portion, the bottom surface and the leading portion collectively form a cutting edge. The body further comprises a portion that is configured to be inserted within a slot within a cutting assembly with the bottom surface and a portion of the leading portion extending outward from the slot, the cutting assembly configured to be rotated by a shaft that extends through a center hole in the cutting assembly and is fixed to the cutting assembly, wherein the leading portion is a surface of the body that faces the direction of rotation of the body as the cutting assembly is rotated. The cutting edge and the leading portion each form a plurality of serrations along at least a portion of a length thereof.

Advantages of the present disclosure will become more apparent to those skilled in the art from the following description of the preferred embodiments of the disclosure that have been shown and described by way of illustration. As will be realized, the disclosed subject matter is capable of other and different embodiments, and its details are capable of modification in various respects. Accordingly, the drawings and description are to be regarded as illustrative in nature and not as restrictive.

### BRIEF DESCRIPTION OF THE DRAWINGS

FIG. 1 is a perspective view of an emulsion system including a cutting assembly and a screen assembled upon a shaft disposed within a housing.

FIG. 2 is a perspective view of an emulsion system with a different cutting assembly, that includes radial knives.

FIG. 3 is a perspective view of the cutting assembly of the system of FIG. 1, depicting one of the cutting arms with a knife installed, and another cutting arm with the knife removed from the cutting arm.

FIG. 4 is a schematic top view depicting a knife in close contact with a surface of an emulsion screen of FIG. 1.

FIG. 4a is a perspective view of a knife in close contact with a surface of an emulsion screen of FIG. 1.

FIG. 5 is a perspective knife that is usable with the system of FIG. 1 or FIG. 2.

FIG. 6 is a detail view of detail A of FIG. 5.

FIG. 7 is a front view of the knife of FIG. 5.

FIG. 8 is top view of the knife of FIG. 5, i.e. a view of the cutting side surface of the knife.

FIG. 9 is a detail view of detail B of FIG. 8.

FIG. 10 is a partial perspective view of a portion of an alternate knife usable with the systems of FIG. 1 or FIG. 2.

FIG. 11 is a front view of an emulsion plate usable with the systems of FIG. 1 or FIG. 2.

FIG. 12. Is a top view of an alternate knife usable with the systems of FIG. 1 or FIG. 2, i.e. a view of the cutting side surface of the knife.

FIG. 13 is a perspective view of another knife that is usable with the system of FIG. 1 or FIG. 2.

FIG. 13a is a front view of the knife of FIG. 13.

FIG. 13b is a top view of the knife of FIG. 13, i.e. a view of the cutting side surface of the knife.

FIG. 14 is a perspective view of a portion of another knife that is usable with the system of FIG. 1 or FIG. 2.

FIG. 15 is a perspective view of a cutting assembly usable with the system of FIG. 1 or 2.

FIG. 15a is detail view of detail AA of FIG. 15.

FIG. 16 is a perspective view of another cutting assembly usable with the system of FIG. 1 or 2.

FIG. 17 is a perspective view of another cutting assembly usable with the system of FIG. 1 or 2.

### DETAILED DESCRIPTION OF THE DRAWINGS

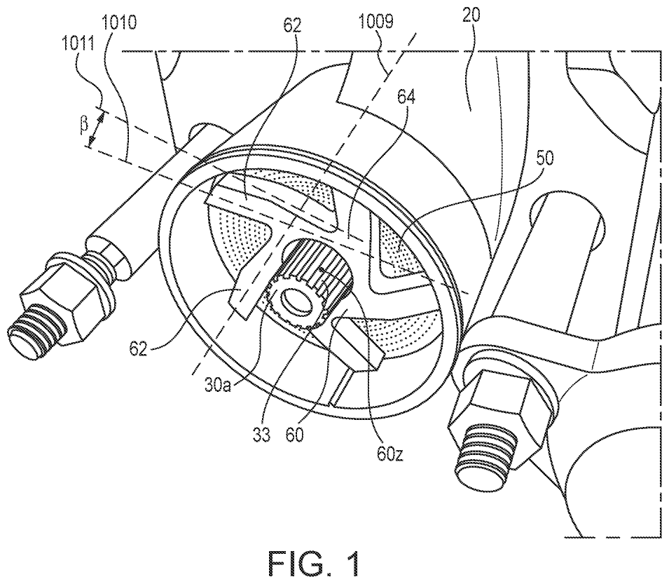

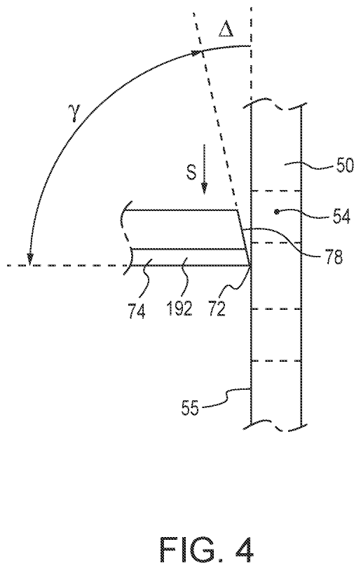

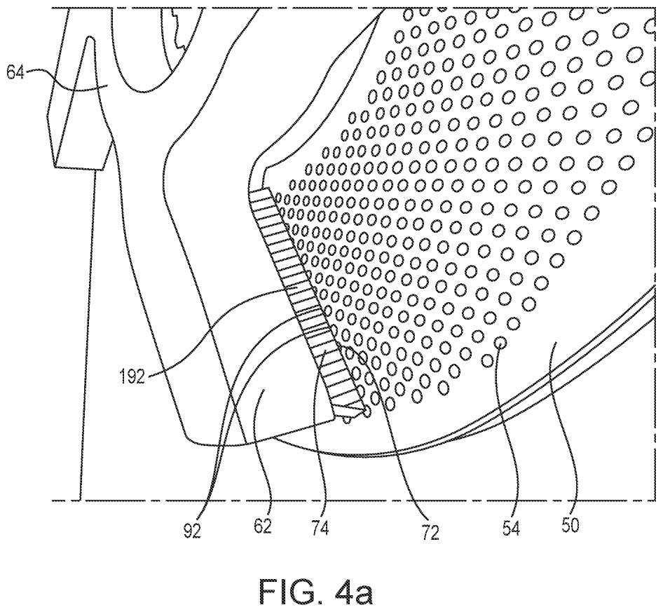

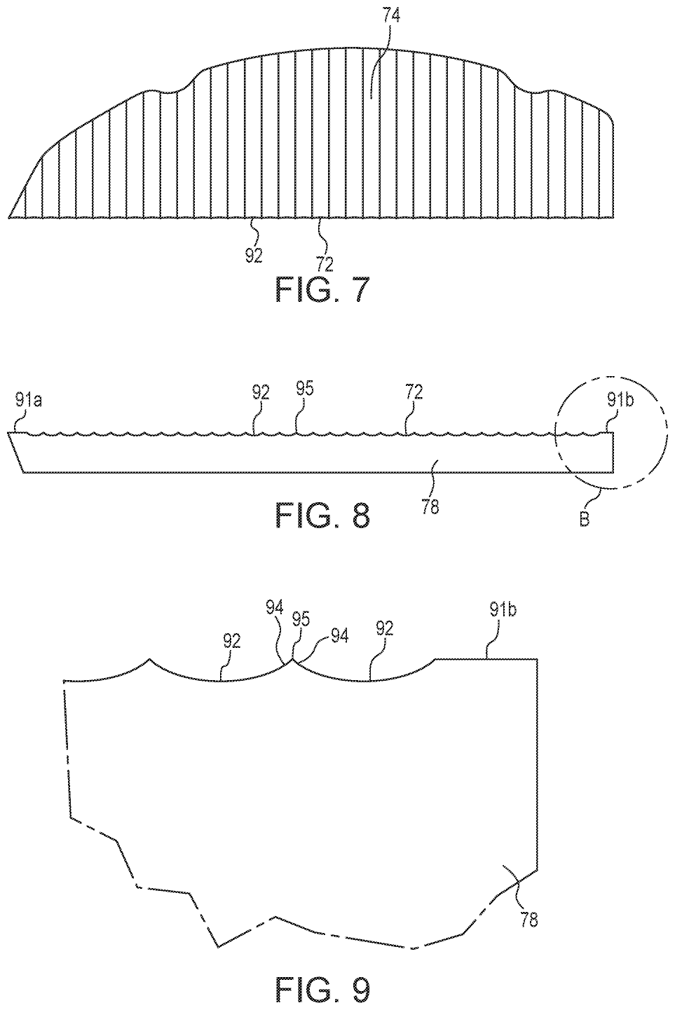

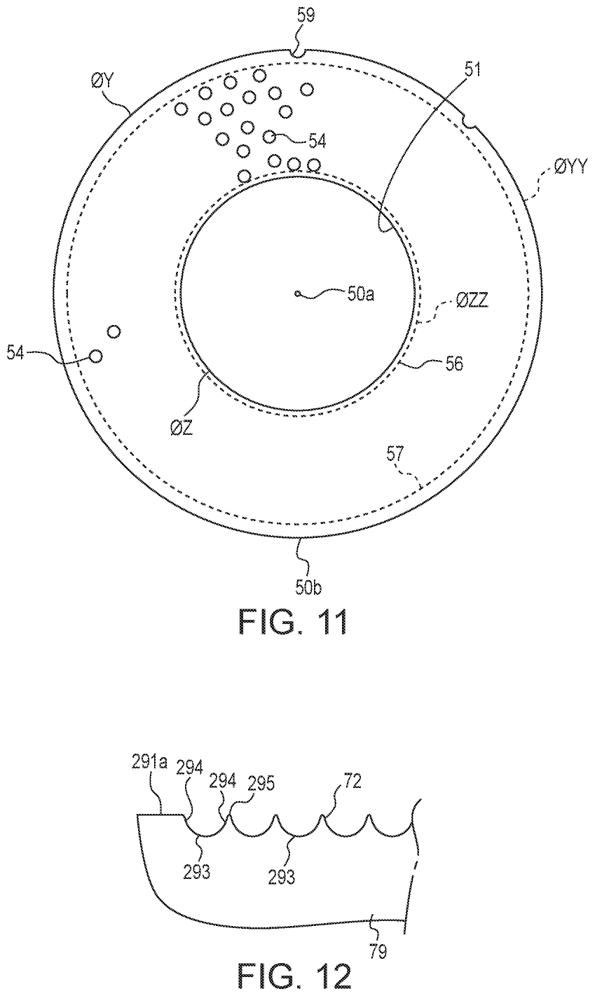

Turning now to FIGS. 1-12, an emulsion or grinding device 10 is provided. The emulsion device 10 is configured to accept a flow of relatively large sized food product, such as cut pieces of meat, as well as bone, plant based product, eggs, egg products, cheese, and blended products that include any of the these items. In some embodiments, the device 10 is used to prepare emulsions of food products that are intended for human consumption where generally bones are removed before the grinding or emulsification process, while in other embodiments the device 10 is used to prepare emulsions of food products that are intended for pet food, where a certain percentage or size of final bone material is allowed within a saleable food unit. Emulsions that are prepared by the device may be used in saleable food products such as hot dogs, sausage, pet foods, and the like. Emulsions may also be prepared that are not intended for commercial sale to an end consumer, but are used in animal feed or for other uses.

During an emulsion process, items such as sinew, connective tissue, cartilage may resist cutting and therefore build up on the front of a screen, which if not properly cut may prevent the knife that rotates proximate (or in contact with) the screen from closely cutting food particles and may physically block the holes in the emulsion screens from allowing cut particles to extend therethrough. The disclosed device has been found to be helpful with cutting these types of items, which are often difficult to cut or resist cutting.

The disclosed device may be beneficial over conventional emulsion devices for various reasons, such as allowing for larger holes within screens still obtaining a desired maximum food product or bone size (pet food applications), to preventing a knife edge from rolling over and therefore premature dulling a knife edge as often evidenced in conventional emulsion systems, prevent bones or food products from being stuck within holes in the screens of the emulsion device, which would reduce flow rate through the device and establish localized low flow zones within the device which could introduce clogging, resistance to the rotating components or other problems known in conventional systems.

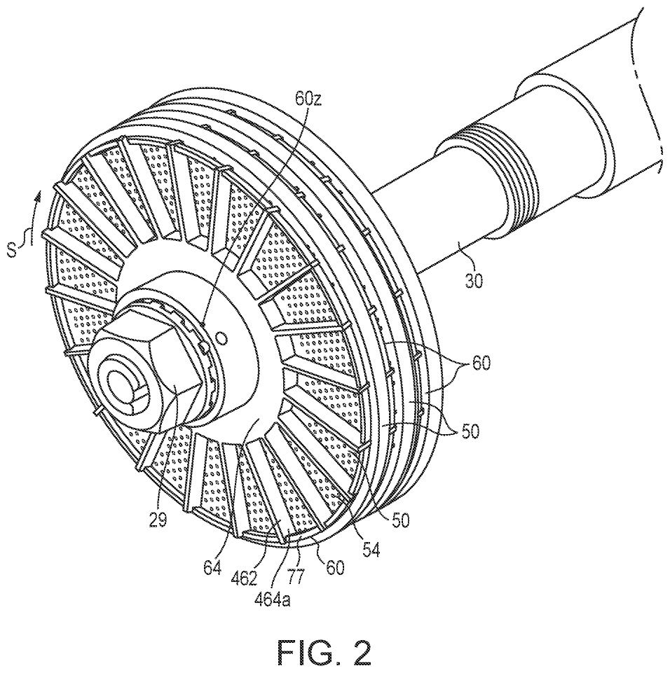

In some embodiments the device 10 includes a shaft 30 that is disposed within a housing 20. The shaft 30 supports one or more assemblies that are disposed in an alternating and arrangement with one or more screens 50 and cutting assemblies 60. In some embodiments, the elements may be arranged (away from the distal end 30a of the shaft and toward the outlet of the housing)—cutting assembly 60, screen 50, cutting assembly 60, screen 50, cutting assembly 60, screen 50, and so forth (only a single cutting assembly 60 and screen 50 is depicted in FIG. 2, but multiple of these would be aligned upon the shaft as desired). In other embodiments a single cutting assembly 60 and screen 50 may be provided, or in other embodiments, a single screen 50 may be provided with cutting assemblies 60 positioned upon opposite sides of the screen, so that food particles are cut initially as they approach the screen, and then a second cut is provided for as the smaller food particles leave the hole 54 in the screen 50.

As discussed in further detail below, the cutting assemblies 60 rotate with rotation of the shaft 30, while the screens 50 are fixed with respect to the housing 20. The housing 20 may be connected to a pump to push food through the screens or a pump that draws a suction downstream of the screens to urge the food through the screens. Other systems may operate with food urged to flow through the screens due (in whole or in part) due to the force of gravity. In other embodiments, a vacuum force may be generated downstream from the screens to vacuum draft the food through the screens. Food is urged to flow through the holes 54 within the plurality of screens 50, and in the presence of rotating cutting assemblies 60, which shear the food product in smaller and smaller sizes. Alternatively, product can be pumped through the housing and the screens and rotating cutting assemblies with the higher inlet pressure urging the food product therethrough. The plurality of cutting assemblies 60 and screens 50 (or in some embodiments single screen 50 with one or two opposite cutting assemblies 60) are disposed upon the shaft 30 and maintained in position with a collar that rotates along with the shaft 30, and a nut may be provided to maintain the collar in position. The components may be positioned as intended with one or more washers or spacers.

One or more screens 50 are provided upon the shaft 30 such that a food product must pass through holes 54 in the screen (screens) in order to pass through the assembly and be pulled out of the housing 20. In some embodiments, each successive screen 50 is the same component, i.e. with the same number of holes 54, the same spacing and pattern of holes 54, and with the same diameter of holes 54. In other embodiments, a first screen 50 may have holes with a first diameter, spacing, etc. while successive screens 50 (which the food product would reach after passing through a hole in the first screen) may have holes with a smaller diameter, larger spacing between adjacent holes, a different hole pattern, all by way of example. The screen 50 may include a first surface 51 that faces toward the inlet of the housing (or the distal end of the shaft 30) and an opposite second surface 52 that faces toward the outlet 8 of the housing. In some embodiments, all or some holes 54 in all or some screens may by cylindrical, while in other embodiments, one or more screens 50 may have truncated conical holes 54, where the truncated end resides through the first surface 51 and the larger diameter end extends through the second surface 52. In some embodiments, the each screen 50 may have holes 54 with the same diameter, while in other embodiments, screens 50 may have holes of different diameter, such as an increasing diameter as the holes extend radially outward from a center portion of the screen.

The screens 50 may include a central opening 53, which is configured to allow the shaft 30 and the spline 37 to extend therethrough, which allows the shaft 30 to rotate with the screen 50 maintaining fixed in the rotational direction. The diameter of the central opening 53 may be larger than the diameter of the spline 37 to allow relative rotation of the shaft 30 with respect to the screens 50.

As discussed below, the screens 50 may be longitudinally moveable within the housing 20 toward and away from the distal end of the shaft 30. In some embodiments, the screens 50 may be keyed to the housing 20, such as with a plurality of recesses 59 that are disposed within an outer edge 50b that key with corresponding projections in the housing, which serve to rotationally fix the screens 50 with respect to the housing 20, but allow the screens 50 to move longitudinally along the housing 20. Alternatively, the screens 50 may include one or more projections that key within recesses within the housing 20.

In some embodiments and with reference to FIG. 11, all of the plurality of emulsion holes 54 (several depicted schematically in FIG. 11) within a plate 50 may be disposed outside of a first circle 56 with a diameter (ZZ) that is just larger than the center hole 51 of the emulsion plate 50 and inside a second circle 57 that is disposed inside of the outer edge 53 of the plate 20. In some embodiments, the first circle 56 may have a diameter that is about 0.3 inches greater than the diameter of the second hole, and the second circle 27 may have a diameter (YY) that is about 0.5 inches less than the diameter of the plate 50. One of ordinary skill in the art with a thorough review and understanding of this specification will understand that the size of the first and second circles with respect to the dimensions plate (inner and outer diameter) and with respect to the emulsion hole 54 diameter may vary based upon the type of food to be emulsified by the system, and based upon the number of plates and cutting assemblies used. The modification and optimization of the various dimensions of the plate 50 (including hole 54 diameter, hole positioning—number of holes within a given area upon the plate, and first and second circle diameters) may be optimized using only routine optimization techniques. The distance between the second circle 57 and the diameter of the plate should be significantly larger than the penetration depth of the registry indentations 59 such that there is sufficient material between the first indentation 59 and adjacent emulsion holes 54 to the first indentations. This minimum space (and therefore the difference in diameter between the plate diameter and the second circle 57) would be understood by one of ordinary skill in the art with a thorough review and understanding of this specification would appreciate that this is a function of the strength properties of the material used for the plate as well as the geometry (especially the width) of the plate 50.

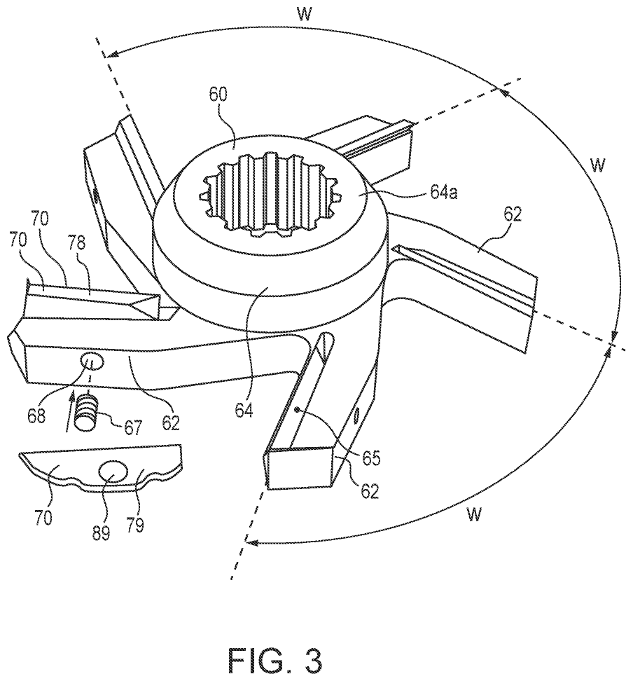

The cutting assemblies 60 are best depicted in FIG. 3. The cutting assemblies 60 may include a hub 64 that includes a spline that fits upon and a corresponding spline 31 upon the shaft 30, which causes the cutting assemblies 60 to rotate with rotation of the shaft while allowing the cutting assemblies 60 to longitudinally slide along the shaft 30 in directions toward and away from the distal end 31 of the shaft 30. Each cutting assembly 60 may longitudinally slide with respect to the shaft 30 independently of the other cutting assemblies 60 and independently of the screens 50 (and likewise, each screen 50 may slide along the shaft 30 independently of each cutting assembly 60 and each screen 50). As discussed below, the relative position of the cutting assemblies 60 upon the shaft 30 (and the screen 50 upon the shaft 30) may be controlled by the position of the collar 80 upon the shaft 30 or with other alignment structures such as spacers, washers, and the like.

Each cutting assembly includes a hub 64, a plurality of arms 62 that extend outward from the hub 64. In some embodiments, the plurality of arms 62 may extend radially outward from the hub 64 such that a centerline line through each arm 62 extends through a center 60Z of aperture 61 of the hub (FIG. 2), while in other embodiments, (FIG. 1) each of the plurality of arms 62 may extend from the hub along a line 1009, 1010 that does not extend through the center of the aperture, but extends through the hub 64. The cutting assembly 60 may have a plurality of arms that spaced at consistent angles (or arc lengths (W) between a consistent structure of each arm, such as a leading edge tip, FIG. 1) with respect to each other such that the cutting knives 70 pass across the same point upon a neighboring screen 50 when the shaft 30 rotates at a constant angular velocity.

The plurality of arms 62 each may include a slot 65 that is configured to receive a portion of a removable knife 70 therein. The slot 65 may be aligned with a hole 68 in the respective arm to allow a fastener 67, such as a set screw, to extend therethrough and to make frictional contact with a portion of the removable knife 70 that extends within the slot 65. The frictional contact maintains the knife 70 fixed within the slot 65. In some embodiments, the knife 70 may have a feature, such as a recess 89, that corresponds with the location where the fastener 67 extends through the hole 68 in the arm to assist with the connection between the fastener and the knife 70. In some embodiments upon assembly, the fastener 67 may be fully tightened upon the knife and then backed off a small amount (e.g. potentially a half turn or a quarter turn) to allow the knife 70 some ability to rotate about the fastener (as shown in the arrows in FIG. 3) so that the knife 70 can rotate within slot 65 as needed if, for example, the screen 50 and the cutting assembly are not aligned exactly parallel to each other upon the shaft 30 and housing 20.

The knife 70 is best shown in FIGS. 3 and 5-10. The knife 70 includes a cutting edge 72, a leading side surface 76, a cutting side surface 78, and a rear side surface 79. Upon assembly of the knifes 70 into the slots 65 upon arms 62 within the cutting assembly, the cutting edge 72, the cutting side surface 78, and a portion of the leading side surface 76 and the rear side surface 79 extends out from the slot 65, while a portion of the leading side surface 76 and the rear side surface 79 each are within the volume of the slot 65 (and are engaged by the fastener).

The cutting edge 72 includes a plurality of serrations 92 along its length, which may extend along the entire length of the cutting edge 72. In other embodiments, the plurality of serrations 92 may extend along a central portion 72a of the cutting edge 72, with one or both end portions 91a, 91b of the cutting edge 72 not including serrations, and instead being a straight edge.

Each serration 92 may include a concave shape with ends that transition at a point 95 with ends of adjacent serrations 92. A point 95 is defined herein to include a region that is formed by the end tip 94 of two adjacent serrations, and includes a length of the cutting edge 72 that transitions between two end tips. The point can include a section that forms the end tips 94 of two adjacent serrations 92 and includes virtually no length between the tips and therefore form a sharp point, and also includes situations where tips from two adjacent serrations are spaced from each other, such as up to about 0.04 inches of space or curvature between the adjacent end tips 94. The point 94 preferably has a sharp point, or a curve as the edge transitions from one serration 92 to an adjacent serration 92. The point 95 may include a continuous curve between the end tips 94 of the adjacent serrations 92.

In some embodiments, all of the serrations 92 along the length of the cutting edge 72 may be formed with the same geometry, while in other embodiments, the serrations 92 may be formed with differing geometry. In one embodiment, the two serrations 92 that establish the last serrations on both the right and left sides of the cutting edge may include geometries that differ from all of the remaining serrations that are inboard of the right and left last serrations. In this embodiment, all of the serrations that are inboard of the right and left last serrations have the same geometry.

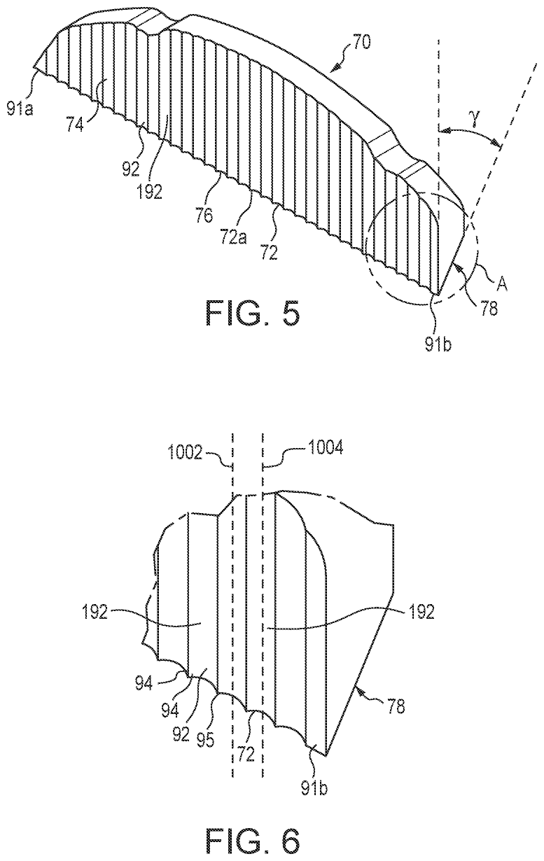

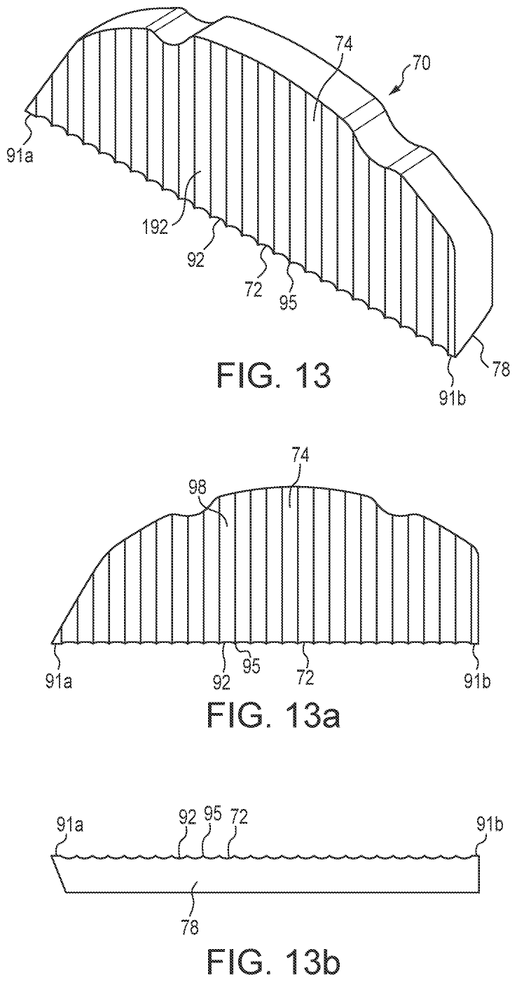

In a preferred embodiment, the cutting edge 72 may be formed with serrations 92 that are spaced from each other with consistent spacing between neighboring serrations. The serrations may each be spaced from each other such that the consistent spacing is about 0.065 inches between centers of each adjacent serration. In this embodiment, the serrations are formed with a depth WW of about 0.10 inches from the collective points 95, which collectively form the outer-most portion of the cutting edge. In this exemplary embodiment, the serrations are each formed with a continuous curve along their length with a diameter of about 0.118 inches. In the embodiment depicted in FIG. 5, the knife is formed with 34 adjacent serrations 92 along the length of the cutting edge 72. In this embodiment, the right and left end portions do not include a serration and instead remain a straight edge 91. In this exemplary embodiment, the straight edge portion on the right and left end portions is about 0.067 inches. In other embodiments, the knife of this preferred embodiment may be formed with a longer or shorter length, such that it includes a differing number of serrations, such as 26 serrations, as depicting in the knife of FIGS. 13-13b.

The term “about” is defined herein to include the reference value as well as a range plus or minus 5% of the reference value dimension inclusive of all values within the range.

In other embodiments, knives can be formed with a cutting edge 72 with a plurality of adjacent serrations 94 with different dimensions and with different geometries. In another exemplary embodiment, the knife may include a cutting edge 72 that includes between 20-40 serrations along its length. Each serration 92 may be formed with a consistent spacing of between about 0.6 and about 0.1 inches. Each serration may be formed with a depth from about 0.007 and 0.15 inches, and each serration may be formed with a curvature that establishes a consistent diameter of between about 0.08 and about 0.15 inches.

In some embodiments, the serrations 92 upon the cutting edge 72 have a width (distance between adjacent points 95) that is the same or about the same as the diameter (or major width if not circular) of the emulsion holes 54 of the plate that is next to the knifes in the assembled emulsion system.

In some embodiments, the cutting edge 72 may include serrations 292 may be formed in an alternate matter from the serrations 92 discussed above. In some embodiments, each serration 292 may include a curved central portion 293 and end portions 294 that are straight. The linear ends of each serration may intersect at the point 295 (similar to the point 95 discussed above).

In some embodiments, all of the arms 62 may include knives 70 that have the same geometry (and surface finishing, including sharpness of the cutting edge 72 at the time of manufacture), while in other embodiments, arms 62 may receive knives that include cutting edges with differing geometries. For example, adjacent arms 62 may include knives that include cutting edges with serrations 72 as discussed above, and then cutting edges with serrations 272 in an alternating manner. This alternating design of the serrations of the cutting edges may allow for different cutting of the food proximate to the plate 50 as the knives with different pass thereby through a single rotation, which may result in the pieces of food that are cut by the knives varying as different knives pass by. The different pieces of cut food may be desirable for the makeup of the final emulsion produced by the system.

In some embodiments, the cutting edge 72 may be formed with a straight edge 91a, 91b on one or both of the right and left end portions. In some embodiments, the straight edges 91 may be a relatively minor percentage of the total length of the total length of the cutting edge, while in other embodiments, the length of the straight edge 91 may be significant. In some embodiments, the left straight edge 91a (which is aligned most proximate to the outer edge 50b of the plate 50) may be provided for the length of the cutting edge 72 that extends outside of the second circle 57 of the plate, and the right straight edge 91b (aligned most proximate to the inner edge 51 of the plate 50) may be provide for the length of the cutting edge 72 that extends inside of the first circle 56 of the plate 50. In other words, the serrations 72 upon the cutting edge extend from a position where a first end of the plurality of serrations 92 aligns with the first circle 56, and an opposite second end of the plurality of serrations aligns with the second circle 57. In some embodiments, the serrations upon the first end do not extend inside the first circle 56, and the serrations upon the second end of the cutting edge 72 do not extend outside of the second circle 57.

In other embodiments, the cutting edge 72 is formed with aligned adjacent serrations 92 that extend the entire cutting edge, with a first serration starting at a first extended end of the cutting edge 72 and the opposite last serration ending at the opposite second extended end of the cutting edge 72.

The leading surface 74 of the knife 70 may include the serrations 192 within the cutting edge 72, such that the serrations 92 upon the cutting edge extend from the cutting edge 72 and across all or a significant portion of the leading surface 74 as serrations 192. The serrations 192 may extend along the leading surface 74 of the knife with the same size, shape, and location as the serrations 92 extend along the cutting edge 72.

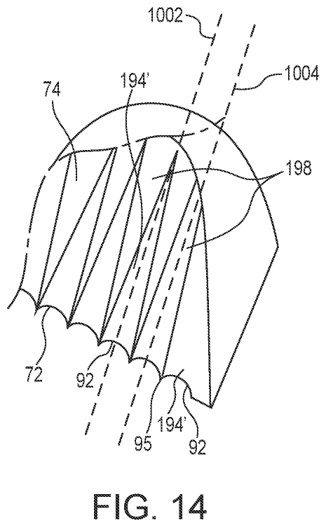

In other embodiments, the serrations 192 may vary in size and/or shape along the length of the leading surface 74. In one example depicted in FIG. 14, the serrations may transition from the cutting edge 72 (92) to the leading surface (192), and may gradually, and in some embodiments continuously, decrease in curvature (diameter of the curve) along the length of the leading surface 74. In other words, the serrations 192 may extend along parallel lines (1001, 1002) from the cutting edge, but result in a decreasing depth as the serrations get further away from the cutting edge 72. In this embodiment, the points 95 between adjacent serrations 92 along the leading surface may grow larger (and at some point may no longer be points (as defined above) and may transition to planar portions 198 with a measurable length between adjacent serrations).

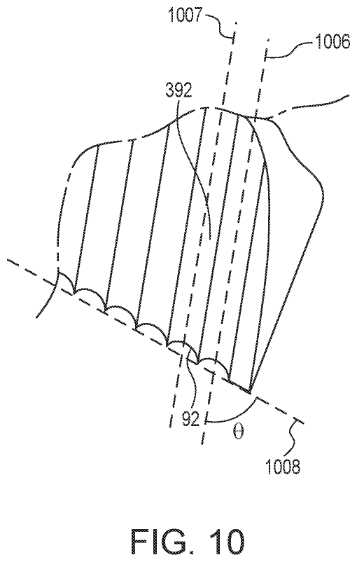

In other embodiments shown in FIG. 10, alternate serrations 392 may travel along the leading edge 74 along parallel lines 1006, 1007 that are not perpendicular to a line 1008 through the collective points 95 in the cutting edge at an acute angle Θ, such that the serrations 392 move from left to right (or right to left) along the leading surface 74 of the knife. In still other embodiments, the serrations may have the same curvature (diameter of the curve) along the length of the serrations across the leading surface 74, but the depth of the serrations may decrease as the serrations extend away from the cutting edge 72. As with the embodiment above with serrations 192, the serrations extend in parallel lines from the cutting edge, but the points 95 between adjacent serrations along the leading surface may grow larger (and at some point may no longer be points (as defined above) and may transition to straight edges with measurable length between adjacent serrations).

With reference to FIG. 5, the bottom surface 78 of the knife 70 may be at an oblique angle γ with respect to the leading surface 74 of the knife 70. This orientation ensures that the leading edge 72 is closest to the surface 55 of the plate, and that the reminder of the bottom surface is further away from the plate 50. With this design, as the knives 70 wear and need to be ground to maintain a sharp cutting edge 72, the cutting edge 72 continues to be most proximate to the surface 55 of the plate 50 through the life of the knife 70. In some embodiments, when the knife 70 is installed within the cutting arm and positioned proximate to a plate 50, the bottom surface 78 is disposed at an acute angle Δ with respect to the proximate surface 55 of the plate. The angle Δ may be within a range of about 2 degrees to about 15 degrees inclusive of all angles therewithin.

The cutting assembly 60 may include differing numbers of cutting arms 62 (which each include a knife 70, such as all or some knives with serrations upon the cutting edge 72 and in some embodiments the leading surface 74), such as four arms, eight arms, sixteen arms, twenty arms, or in other embodiments within a range of within four and twenty arms including the end points of this range. The cutting arms are preferably disposed at consistent angular spacing from neighboring elements 62 along the perimeter of the hub 64, while the cutting arms 62 could be disposed within a pattern of differing spaces, such as a first angular spacing between two adjacent cutting arms 62 and then double or half again the first angle spacing with the next cutting arms and then back to the first angular spacing with the next cutting arm. The number and positioning of the cutting arms 64 is preferably balanced around the circumference of the cutting assembly 60 for smooth rotation with a constant input torque on the shaft 30.

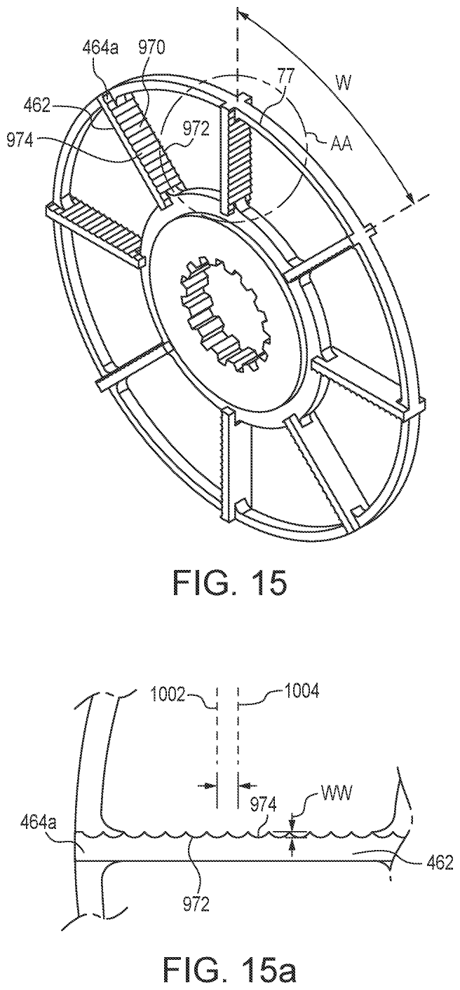

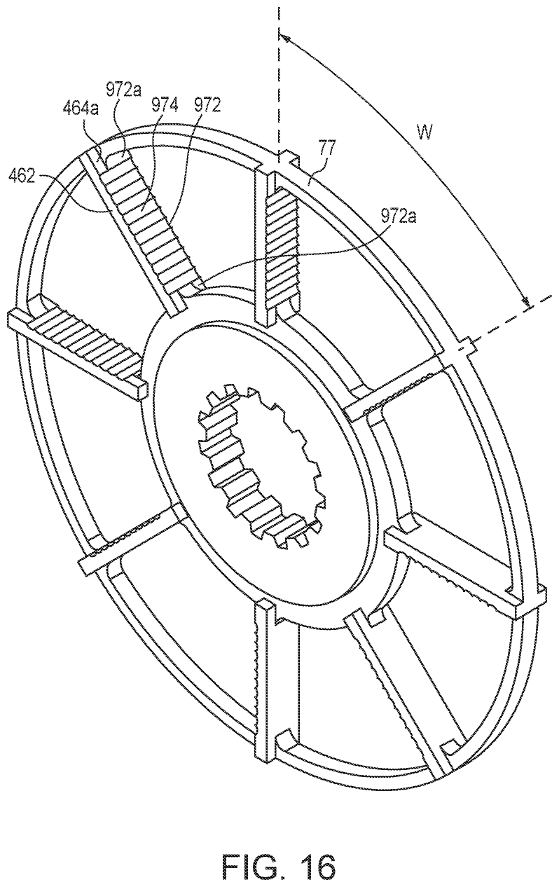

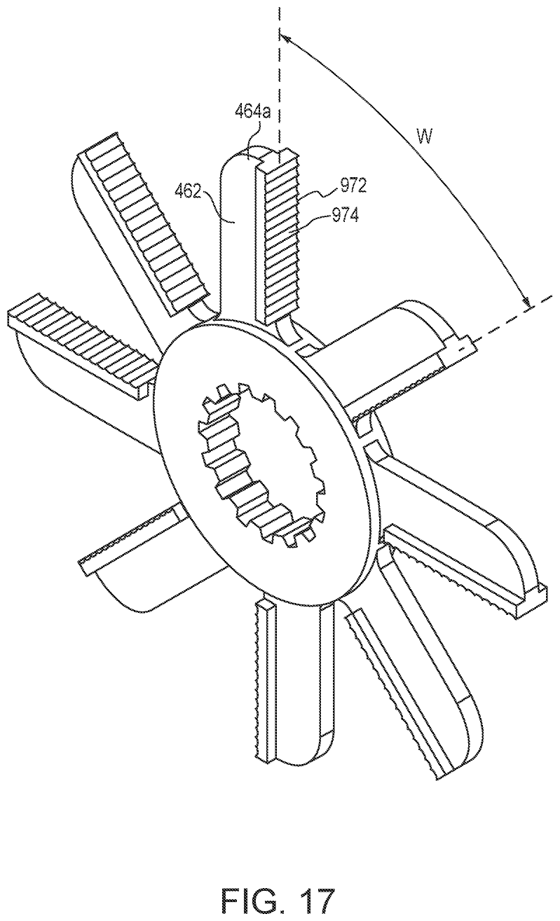

The cutting assembly 60 may be formed with cutting arms 462 that extend radially outward from the center of the assembly (FIGS. 2, 15-17). In this embodiment, the cutting arms may include slots that hold knives, like the knives 70 with a cutting edge 72 and in some embodiments a leading surface 74 with a plurality of serrations 92/192 as discussed herein, or in other embodiments the knives 970 may be formed directly onto the material that forms the arm as depicted in FIGS. 15-17 such that the cutting edges and serrated side surfaces of the arm are formed monolithically with the material that forms the respective cutting arm. In these embodiments, the arms 462 include a serrated cutting edge 972 and a serrated leading or side surface 974. The serrated cutting edge 972 may extend the entire length of each arm (FIGS. 15, 15a, 17) while in other embodiments (FIG. 16) the serrated cutting edge 972 may be within a central portion and include gaps 972a on one or both ends to allow space for bone fragments, sinew, cartilage or other items that are not able to be effectively cut to pass within these portions and leave the emulsification system.

In other embodiments, the cutting arms 62 extend at an offset angle from the hub 64, as depicted in FIGS. 1, 3. For example, the cutting arms 62 may extend from the hub such that a line (1009, 1010) through arm 62 extends through the hub 64 but does not extend through center 60z of the cutting assembly 60. In some embodiments, the arms 62 may each extend substantially tangentially from a circular central hub 64. The term “substantially” is specifically defined herein to mean a direction that approximates tangentially but does not necessary form an exact geometric tangent line with the outer edge of the central hub as shown in FIG. 3. For example, a cutting arm 62 may extend substantially tangentially if it extends at an angle B of less than 15 degrees from a line 1011 that is tangential to the outer edge of the hub 64.

The hub 64 of the cutting assembly 60 may include a spline 64a that is configured to receive torque from the shaft 30, and specifically a corresponding spline, and therefore rotate with the shaft 30. A cap 29 may be provided to fix the assembly of cutting assemblies 60 and screens 50 in position, which may be adjustable to control the distance between the cutting edges 72 of the knives and the adjacent surface 55 of the screens 50 for proper cutting of food particles within the system 10.

In some embodiments the outer tips 464a of the cutting arms 462 may be fixed to a hoop 77 that connects to the outer tips 464a of each cutting arm 464, which increases the stiffness and stability of the cutting assembly 60.

While the preferred embodiments of the disclosed have been described, it should be understood that the invention is not so limited and modifications may be made without departing from the disclosure. The scope of the disclosure is defined by the appended claims, and all devices that come within the meaning of the claims, either literally or by equivalence, are intended to be embraced therein.

The preferred embodiments can be further understood with reference to the Numbered Paragraphs provided below:

Numbered Paragraph 1: An emulsification system, comprising:
a shaft capable of rotation, and a housing that encloses the shaft;
one or more screens that are disposed about the shaft and within the housing, each of the plurality of screens are fixed with respect to the housing and remain stationary as the shaft rotates, each screen has a plurality of thru holes to allow a food product to pass therethrough;
one or more cutting assemblies that are disposed about the shaft and within the housing, the one or more cutting assemblies fixed to the shaft such that each cutting assembly rotates with rotation of the shaft;
each of the one or more cutting assemblies includes a hub with a plurality of arms that extend from the hub, the plurality of arms each include a slot for receipt of a removable knife;
each of the plurality of arms removably receives a cutting knife within the slot, wherein each cutting knife comprises a cutting edge and a side surface, the cutting edge and a portion of the side surface extends out of the slot when the knife is installed within the respective slot;
the cutting edge and the side surface each form a plurality of serrations along at least a portion of a length thereof.

Numbered Paragraph 2: The emulsification system of Numbered Paragraph 1, wherein the plurality of serrations are each a plurality of concave portions, ends of internal concave portions transition with ends of adjacent concave portions at a point.

Numbered Paragraph 3: The emulsification system of Numbered Paragraph 2, wherein the plurality of concave portions extends along the side surface from the cutting edge.

Numbered Paragraph 4: The emulsification system of Numbered Paragraph 3, wherein the plurality of concave portions extending along the side surface from the cutting edge each have a uniform concavity along their length along the side surface.

Numbered Paragraph 5: The emulsification system of Numbered Paragraph 3, wherein the plurality of concave portions extending along the side surface from the cutting edge have a decreasing concavity along their length as a distance along the side surface from the cutting edge decreases.

Numbered Paragraph 6: The emulsification system of any one of Numbered Paragraphs 1-5, wherein the plurality of thru holes on each of the one or more screens are arranged within a portion of the screen that is bounded between an outer circle proximate to an outer edge of the screen and an inner circle that is proximate to a hole in the screen that allows the shaft to pass through, wherein the plurality of serrations upon each cutting knife extend upon the cutting knife from a position where a first end of the plurality of serrations aligns with the outer circle and an opposite second end of the plurality of serrations aligns with the inner circle.

Numbered Paragraph 7: The emulsification system of Numbered Paragraph 6, wherein the plurality of serrations do not extend past the outer circle toward the outer edge of the screen and the plurality of serrations do not extend past the inner circle toward the hole of the screen.

Numbered Paragraph 8: The emulsification system of Numbered Paragraph 1, wherein the plurality of serrations extend for an entire length of the cutting edge.

Numbered Paragraph 9: The emulsification system of any one of Numbered Paragraphs 1-8, wherein one or more of the plurality of serrations include straight portions that intersect at a point.

Numbered Paragraph 10: The emulsification system of Numbered Paragraph 9, wherein all of the plurality of serrations include straight portions that intersect at a point.

Numbered Paragraph 11: The emulsification system of any one of Numbered Paragraphs 1-10, wherein each of the plurality of serrations have a width that is about the same as the diameter of each of the thru holes upon a respective screen of the one or more screens that the cutting knife is aligned with.

Numbered Paragraph 12: The emulsification system of any one of Numbered Paragraphs 1-11, wherein the arms extend radially from the hub.

Numbered Paragraph 13: The emulsification system of any one of Numbered Paragraphs 1-11, wherein the arms each extend at an offset angle from the hub.

Numbered Paragraph 14: The emulsification system of Numbered Paragraph 13, wherein the arms extend substantially tangentially from the hub.

Numbered Paragraph 15: The emulsification system of any one of Numbered Paragraphs 1-14, wherein a bottom surface of each cutting knife is at an oblique angle such that when each cutting knife is installed within the respective arm of the plurality of arms, the bottom surface is not parallel with a face of the respective screen that is proximate to the cutting knife, wherein the cutting edge is closest to the face than a remaining portion of the bottom surface.

Numbered Paragraph 16: The emulsification system of Numbered Paragraph 15, wherein the bottom surface establishes an angle of between about 2 to about 10 degrees with respect to the face of the respective screen that is proximate to the cutting knife.

Numbered Paragraph 17: A cutting knife for an emulsification system, comprising:
a body with a bottom surface and a leading portion, the bottom surface and the leading portion collectively form a cutting edge,
the body further comprises a portion that is configured to be inserted within a slot within a cutting assembly with the bottom surface and a portion of the leading portion extending outward from the slot, the cutting assembly configured to be rotated by a shaft that extends through a center hole in the cutting assembly and is fixed to the cutting assembly, wherein the leading portion is a surface of the body that faces the direction of rotation of the body as the cutting assembly is rotated;
the cutting edge and the leading portion each form a plurality of serrations along at least a portion of a length thereof.

Numbered Paragraph 18: The cutting knife for an emulsification system of Numbered Paragraph 17, wherein the plurality of serrations are each a plurality of concave portions, ends of internal concave portions transition with ends of adjacent concave portions at a point.

Numbered Paragraph 19: The cutting knife for an emulsification system of Numbered Paragraph 18, wherein the plurality of concave portions extends along the leading portion from the cutting edge.

Numbered Paragraph 20: The cutting knife for an emulsification system of any one of Numbered Paragraphs 18-19, wherein the plurality of concave portions extending along the leading portion from the cutting edge each have a uniform concavity along their length along the leading portion.

Numbered Paragraph 21: The cutting knife for an emulsification system of any one of Numbered Paragraphs 18-20, wherein the plurality of concave portions extending along the leading portion from the cutting edge have a decreasing concavity along their length as a distance along the leading portion from the cutting edge decreases.

Numbered Paragraph 22: The cutting knife for an emulsification system of any one of Numbered Paragraphs 17-21, wherein the plurality of serrations extend for an entire length of the cutting edge.

Numbered Paragraph 23: The cutting knife for an emulsification system of any one of Numbered Paragraphs 17-22, wherein all of the plurality of serrations include straight portions that intersect at a point.

Numbered Paragraph 24: The cutting knife for an emulsification system of any one of Numbered Paragraphs 17-23, wherein a bottom surface of the body is at an oblique angle such that when the body is installed within a cutting assembly and positioned proximate to an emulsion screen, the bottom surface is not parallel with a face of emulsion screen that is proximate to the bottom surface, wherein the cutting edge is closest to the face than a remaining portion of the bottom surface.

Numbered Paragraph 25: The cutting knife for an emulsification system of Numbered Paragraph 24, wherein the bottom surfaces establishes an angle of between about 2 to about 10 degrees with respect to the face of the emulsion screen that is proximate to the cutting knife.

Numbered Paragraph 26: An emulsification system, comprising:
a shaft capable of rotation, and a housing that encloses the shaft;
one or more screens that are disposed about the shaft and within the housing, each of the plurality of screens are fixed with respect to the housing and remain stationary as the shaft rotates, each screen has a plurality of thru holes to allow a food product to pass therethrough;
one or more cutting assemblies that are disposed about the shaft and within the housing, the one or more cutting assemblies fixed to the shaft such that each cutting assembly rotates with rotation of the shaft;
each of the one or more cutting assemblies includes a hub with a plurality of arms that extend from the hub, the plurality of arms include a sharpened cutting edge and a side surface, wherein each of the one or more cutting assemblies is positioned with respect to a screen of the plurality of screens with the cutting edge proximate to or in contact with the screen during operation;
wherein each cutting edge and side surface each form a plurality of serrations along at least a portion of a length thereof.

Numbered Paragraph 27: The emulsification system of Numbered Paragraph 26, wherein the plurality of serrations are each a plurality of concave portions, ends of internal concave portions transition with ends of adjacent concave portions at a point.

Numbered Paragraph 28: The emulsification system of either of Numbered Paragraphs 26 or 27, wherein the plurality of concave portions extends along the side surface from the cutting edge.

Numbered Paragraph 29: The emulsification system of any one of Numbered Paragraphs 26-28, wherein the plurality of concave portions extending along the side surface from the cutting edge each have a uniform concavity along their length along the side surface.

Numbered Paragraph 30: The emulsification system of any one of Numbered Paragraphs 26-28, wherein the plurality of concave portions extending along the side surface from the cutting edge have a decreasing concavity along their length as a distance along the side surface from the cutting edge decreases.

Numbered Paragraph 31: The emulsification system of any one of Numbered Paragraphs 26-30, wherein the plurality of thru holes on each of the one or more screens are arranged within a portion of the screen that is bounded between an outer circle proximate to an outer edge of the screen and an inner circle that is proximate to a hole in the screen that allows the shaft to pass through, wherein the plurality of serrations upon each cutting knife extend upon the cutting knife from a position where a first end of the plurality of serrations aligns with the outer circle and an opposite second end of the plurality of serrations aligns with the inner circle.

Numbered Paragraph 32: The emulsification system of Numbered Paragraph 31, wherein the plurality of serrations do not extend past the outer circle toward the outer edge of the screen and the plurality of serrations do not extend past the inner circle toward the hole of the screen.

Numbered Paragraph 33: The emulsification system of Numbered Paragraph 26, wherein the plurality of serrations extend for an entire length of the cutting edge.

Numbered Paragraph 34: The emulsification system of any one of Numbered Paragraphs 26-33, wherein one or more of the plurality of serrations include straight portions that intersect at a point.

Numbered Paragraph 35: The emulsification system of Numbered Paragraph 34, wherein all of the plurality of serrations include straight portions that intersect at a point.

Numbered Paragraph 36: The emulsification system of any one of Numbered Paragraphs 26-35, wherein each of the plurality of serrations have a width that is about the same as the diameter of each of the thru holes upon a respective screen of the one or more screens that the cutting knife is aligned with.

Numbered Paragraph 37: The emulsification system of any one of Numbered Paragraphs 26-36, wherein the arms extend radially from the hub.

Numbered Paragraph 38: The emulsification system of any one of Numbered Paragraphs 26-36, wherein the arms each extend at an offset angle from the hub.

Numbered Paragraph 39: The emulsification system of any one of Numbered Paragraphs 26-36, wherein the arms extend substantially tangentially from the hub.

Numbered Paragraph 40: The emulsification system of any one of Numbered Paragraphs 26-39, wherein a bottom surface of each cutting knife is at an oblique angle such that when each cutting knife is installed within the respective arm of the plurality of arms, the bottom surface is not parallel with a face of the respective screen that is proximate to the cutting knife, wherein the cutting edge is closest to the face than a remaining portion of the bottom surface.

Numbered Paragraph 41: The emulsification system of Numbered Paragraph 40, wherein the bottom surface establishes an angle of between about 2 to about 10 degrees with respect to the face of the respective screen that is proximate to the cutting knife.

Numbered Paragraph 42: A cutting assembly for an emulsification system, comprising:
a hub with a plurality of arms that extend from the hub, the plurality of arms comprise a cutting knife, wherein the cutting knife includes a cutting edge, wherein a bottom surface and a side surface each extend from the cutting edge wherein each cutting edge and side surface form a plurality of serrations along a least a portion of a length thereof;
wherein the plurality of arms extend from the hub with a constant arc length between adjacent arms around a circumference of the cutting assembly.

Numbered Paragraph 43: The cutting assembly of Numbered Paragraph 42, wherein each arm comprises a slot, wherein each slot removably receives a cutting knife within the slot, wherein each cutting knife includes the cutting edge and the side surface, wherein the cutting edge and a portion of the side surface extends out of the slot when the knife is installed within the respective slot.

Numbered Paragraph 44: The cutting assembly of Numbered Paragraph 42, wherein the cutting edge and side surface of each arm is formed monolithically with the structure that forms the arm.

Numbered Paragraph 45: The cutting assembly of any one of Numbered Paragraphs 42-44, wherein the plurality of serrations are each a plurality of concave portions, ends of internal concave portions transition with ends of adjacent concave portions at a point.

Numbered Paragraph 46: The cutting assembly of any one of Numbered Paragraphs 42-45, wherein the plurality of concave portions extends along the side surface from the cutting edge.

Numbered Paragraph 47: The cutting assembly of any one of Numbered Paragraphs 42-46, wherein the plurality of concave portions extending along the side surface from the cutting edge each have a uniform concavity along their length along the side surface.

Numbered Paragraph 48: The cutting assembly of any one of Numbered Paragraphs 42-46, wherein the plurality of concave portions extending along the side surface from the cutting edge have a decreasing concavity along their length as a distance along the side surface from the cutting edge decreases.

Numbered Paragraph 49: The cutting assembly of any one of Numbered Paragraphs 42-48, wherein the plurality of serrations do not extend all of the way to inner and out end portions of the respective arms.

Numbered Paragraph 50: The cutting assembly of any one of Numbered Paragraphs 42-48, wherein the plurality of serrations extend for an entire length of the cutting edge.

Numbered Paragraph 51: The cutting assembly of any one of Numbered Paragraphs 42-50, wherein one or more of the plurality of serrations include straight portions that intersect at a point.

Numbered Paragraph 52: The cutting assembly of Numbered Paragraph 51, wherein all of the plurality of serrations include straight portions that intersect at a point.

Numbered Paragraph 53: The cutting assembly of any one of Numbered Paragraphs 42-52, wherein each of the plurality of serrations have a width that is about the same as the diameter of each of the thru holes upon a respective screen of the one or more screens that the cutting knife is aligned with.

Numbered Paragraph 54: The cutting assembly of any one of Numbered Paragraphs 42-53, wherein the arms extend radially from the hub.

Numbered Paragraph 55: The cutting assembly of any one of Numbered Paragraphs 42-53, wherein the arms each extend at an offset angle from the hub.

Numbered Paragraph 56: The cutting assembly of Numbered Paragraph 55, wherein the arms extend substantially tangentially from the hub.

Numbered Paragraph 57: The cutting assembly of any one of Numbered Paragraphs 42-56, wherein a bottom surface of each cutting knife is at an oblique angle such that bottom surface is not parallel with a surface that is aligned to be simultaneously parallel to or in contact with each of the cutting edges of the cutting assembly, wherein the cutting edge is closest to the surface than a remaining portion of the bottom surface.

Numbered Paragraph 58: The cutting assembly of Numbered Paragraph 57, wherein the bottom surface establishes an angle of between about 2 to about 10 degrees with respect to the surface.

1. An emulsification system, comprising:
a shaft capable of rotation, and a housing that encloses the shaft;
one or more screens that are disposed about the shaft and within the housing, each of the plurality of screens are fixed with respect to the housing and remain stationary as the shaft rotates, each screen has a plurality of thru holes to allow a food product to pass therethrough;
one or more cutting assemblies that are disposed about the shaft and within the housing, the one or more cutting assemblies fixed to the shaft such that each cutting assembly rotates with rotation of the shaft;
each of the one or more cutting assemblies includes a hub with a plurality of arms that extend from the hub, the plurality of arms each include a slot for receipt of a removable knife;
each of the plurality of arms removably receives a cutting knife within the slot, wherein each cutting knife comprises a cutting edge and a side surface, the cutting edge and a portion of the side surface extends out of the slot when the knife is installed within the respective slot;
the cutting edge and the side surface each form a plurality of serrations along at least a portion of a length thereof.

2. The emulsification system of claim 1, wherein the plurality of serrations are each a plurality of concave portions, ends of internal concave portions transition with ends of adjacent concave portions at a point.

3. The emulsification system of claim 2, wherein the plurality of concave portions extends along the side surface from the cutting edge.

4. The emulsification system of claim 3, wherein the plurality of concave portions extending along the side surface from the cutting edge each have a uniform concavity along their length along the side surface.

5. The emulsification system of claim 3, wherein the plurality of concave portions extending along the side surface from the cutting edge have a decreasing concavity along their length as a distance along the side surface from the cutting edge decreases.

6. The emulsification system of claim 1, wherein the plurality of thru holes on each of the one or more screens are arranged within a portion of the screen that is bounded between an outer circle proximate to an outer edge of the screen and an inner circle that is proximate to a hole in the screen that allows the shaft to pass through, wherein the plurality of serrations upon each cutting knife extend upon the cutting knife from a position where a first end of the plurality of serrations aligns with the outer circle and an opposite second end of the plurality of serrations aligns with the inner circle.

7. The emulsification system of claim 6, wherein the plurality of serrations do not extend past the outer circle toward the outer edge of the screen and the plurality of serrations do not extend past the inner circle toward the hole of the screen.

8. The emulsification system of claim 1, wherein the plurality of serrations extend for an entire length of the cutting edge.

9. The emulsification system of claim 1, wherein one or more of the plurality of serrations include straight portions that intersect at a point.

10. The emulsification system of claim 9, wherein all of the plurality of serrations include straight portions that intersect at a point.

11. The emulsification system of claim 1, wherein each of the plurality of serrations have a width that is about the same as the diameter of each of the thru holes upon a respective screen of the one or more screens that the cutting knife is aligned with.

12. The emulsification system of claim 1, wherein the arms extend radially from the hub.

13. The emulsification system of claim 1, wherein the arms each extend at an offset angle from the hub.

14. The emulsification system of claim 2, wherein the arms extend substantially tangentially from the hub.

15. The emulsification system of claim 1, wherein a bottom surface of each cutting knife is at an oblique angle such that when each cutting knife is installed within the respective arm of the plurality of arms, the bottom surface is not parallel with a face of the respective screen that is proximate to the cutting knife, wherein the cutting edge is closest to the face than a remaining portion of the bottom surface.

16. The emulsification system of claim 15, wherein the bottom surface establishes an angle of between about 2 to about 10 degrees with respect to the face of the respective screen that is proximate to the cutting knife.

17. A cutting knife for an emulsification system, comprising:
a body with a bottom surface and a leading portion, the bottom surface and the leading portion collectively form a cutting edge,
the body further comprises a portion that is configured to be inserted within a slot within a cutting assembly with the bottom surface and a portion of the leading portion extending outward from the slot, the cutting assembly configured to be rotated by a shaft that extends through a center hole in the cutting assembly and is fixed to the cutting assembly, wherein the leading portion is a surface of the body that faces the direction of rotation of the body as the cutting assembly is rotated;
the cutting edge and the leading portion each form a plurality of serrations along at least a portion of a length thereof.

18. The cutting knife for an emulsification system of claim 17, wherein the plurality of serrations are each a plurality of concave portions, ends of internal concave portions transition with ends of adjacent concave portions at a point.

19. The cutting knife for an emulsification system of claim 18, wherein the plurality of concave portions extends along the leading portion from the cutting edge.

20. The cutting knife for an emulsification system of claim 19, wherein the plurality of concave portions extending along the leading portion from the cutting edge each have a uniform concavity along their length along the leading portion.

21. The cutting knife for an emulsification system of claim 19, wherein the plurality of concave portions extending along the leading portion from the cutting edge have a decreasing concavity along their length as a distance along the leading portion from the cutting edge decreases.

22. The cutting knife for an emulsification system of claim 17, wherein the plurality of serrations extend for an entire length of the cutting edge.

23. The cutting knife for an emulsification system of claim 22, wherein all of the plurality of serrations include straight portions that intersect at a point.

24. The cutting knife for an emulsification system of claim 17, wherein a bottom surface of the body is at an oblique angle such that when the body is installed within a cutting assembly and positioned proximate to an emulsion screen, the bottom surface is not parallel with a face of emulsion screen that is proximate to the bottom surface, wherein the cutting edge is closest to the face than a remaining portion of the bottom surface.

25. The cutting knife for an emulsification system of claim 24, wherein the bottom surfaces establishes an angle of between about 2 to about 10 degrees with respect to the face of the emulsion screen that is proximate to the cutting knife.

26. An emulsification system, comprising:
a shaft capable of rotation, and a housing that encloses the shaft;
one or more screens that are disposed about the shaft and within the housing, each of the plurality of screens are fixed with respect to the housing and remain stationary as the shaft rotates, each screen has a plurality of thru holes to allow a food product to pass therethrough;
one or more cutting assemblies that are disposed about the shaft and within the housing, the one or more cutting assemblies fixed to the shaft such that each cutting assembly rotates with rotation of the shaft;
each of the one or more cutting assemblies includes a hub with a plurality of arms that extend from the hub, the plurality of arms include a sharpened cutting edge and a side surface, wherein each of the one or more cutting assemblies is positioned with respect to a screen of the plurality of screens with the cutting edge proximate to or in contact with the screen during operation;
wherein each cutting edge and side surface each form a plurality of serrations along at least a portion of a length thereof.

27. The emulsification system of claim 26, wherein the plurality of serrations are each a plurality of concave portions, ends of internal concave portions transition with ends of adjacent concave portions at a point.

28. The emulsification system of claim 27, wherein the plurality of concave portions extends along the side surface from the cutting edge.

29. The emulsification system of claim 28, wherein the plurality of concave portions extending along the side surface from the cutting edge each have a uniform concavity along their length along the side surface.

30. The emulsification system of claim 28, wherein the plurality of concave portions extending along the side surface from the cutting edge have a decreasing concavity along their length as a distance along the side surface from the cutting edge decreases.

31. The emulsification system of claim 26, wherein the plurality of thru holes on each of the one or more screens are arranged within a portion of the screen that is bounded between an outer circle proximate to an outer edge of the screen and an inner circle that is proximate to a hole in the screen that allows the shaft to pass through, wherein the plurality of serrations upon each cutting knife extend upon the cutting knife from a position where a first end of the plurality of serrations aligns with the outer circle and an opposite second end of the plurality of serrations aligns with the inner circle.

32. The emulsification system of claim 31, wherein the plurality of serrations do not extend past the outer circle toward the outer edge of the screen and the plurality of serrations do not extend past the inner circle toward the hole of the screen.

33. The emulsification system of claim 26, wherein the plurality of serrations extend for an entire length of the cutting edge.

34. The emulsification system of claim 26, wherein one or more of the plurality of serrations include straight portions that intersect at a point.

35. The emulsification system of claim 34, wherein all of the plurality of serrations include straight portions that intersect at a point.

36. The emulsification system of claim 26, wherein each of the plurality of serrations have a width that is about the same as the diameter of each of the thru holes upon a respective screen of the one or more screens that the cutting knife is aligned with.

37. The emulsification system of claim 26, wherein the arms extend radially from the hub.

38. The emulsification system of claim 26, wherein the arms each extend at an offset angle from the hub.

39. The emulsification system of claim 27, wherein the arms extend substantially tangentially from the hub.

40. The emulsification system of claim 26, wherein a bottom surface of each cutting knife is at an oblique angle such that when each cutting knife is installed within the respective arm of the plurality of arms, the bottom surface is not parallel with a face of the respective screen that is proximate to the cutting knife, wherein the cutting edge is closest to the face than a remaining portion of the bottom surface.

41. The emulsification system of claim 40, wherein the bottom surface establishes an angle of between about 2 to about 10 degrees with respect to the face of the respective screen that is proximate to the cutting knife.
